(19) United States
(12) Patent Application Publication
(10) Pub. No.: US 2026/0111349 A1
(43) Pub. Date: Apr. 23, 2026

(54) METHOD AND SYSTEM FOR END-TO-END DATA-DRIVEN API TESTING AND INTEGRATION WITH METADATA-DRIVEN PROGRAMMING

(71) Applicant: ALECTRA UTILITIES CORPORATION, Woodbridge (CA)

(72) Inventors: Geri YIN, Vaughan (CA); Subhnamdeep (Neetu) GARCHA, Kitchener (CA); Keith HEMINGWAY, Newmarket (CA); Michael SHIELDS, Toronto (CA)

(21) Appl. No.: 18/922,659

(22) Filed: Oct. 22, 2024

(51) Int. Cl. G06F 11/3668

(52) U.S. Cl. CPC G06F 11/3688; G06F 11/3684

(57) ABSTRACT

There is provided a method and system for end-to-end data-driven application program interface (API) testing and integration with metadata-driven programming.

### FIELD OF INVENTION

The present invention pertains to improvements to the field of computer processing and more particularly to data-driven application program interface (API) testing, integration, and metadata-driven programming.

### BACKGROUND

Application program interfaces (APIs) play a pivotal role in modern data exchanges. Though such exchanges are often between two or more devices coupled for communication, other environments are applicable. Efficient testing and integration of APIs with varying structures and requirements remains a challenge. It is desired too to provide an API testing approach that is adaptable and extendible.

### SUMMARY

Aspects of the disclosure herein will be understood to those of ordinary skill in the art, including those summarized in the following numbered statements, which are not necessarily exhaustive.

Statement 1: A computer implemented method of automated testing of a target computing system having one or more application programming interfaces (APIs) for interacting with the target computing system. In an embodiment, the method comprises: storing a plurality of test scenario instances to a database, the test scenario instances comprising metadata with which to define API requests to communicate to the computing system to test the target computing system by simulating a use scenario therefor, each API request comprising an API request payload including test scenario data in accordance with the use scenario; storing a plurality of test scenario data for use as instances of test scenario data for instances of API requests; retrieving, from the database, metadata of a test scenario instance and an instance of test scenario data responsive to the use scenario to be tested; generating the API request and the API request payload dynamically based on the metadata and instance of the test scenario data; allocating unique identifiers within the API request payload for chaining multiple API requests based on the metadata; and communicating the API request with the API request payload to the target computing system to obtain an API response comprising an API response payload.

Statement 2: The method of Statement 1, wherein the instance of test scenario data retrieved comprises one or more of a fixed data element or a dynamically generated data element.

Statement 3: The method of Statement 1 or 2, wherein the instance of test scenario data retrieved includes session data, API instructions, JSON structures, numeric values, or Boolean values, or combinations thereof.

Statement 4: The method of any one of Statements 1 to 3, wherein the unique identifiers within the API request payload enable chaining of multiple API requests by referencing previous API response data from previous API response payloads.

Statement 5: The method of any one of Statements 1 to 4, comprising iterating through the multiple API requests in accordance with the metadata and API responses received in the chain.

Statement 6: The method of any one of Statements 1 to 5 comprising receiving the API response in response to the API request; storing the API reply to the database.

Statement 7: The method of Statement 6 comprising: parsing the API response to identify data elements of the API response payload; registering the identified data elements in a normalized fashion; and storing the normalized API response data in the database.

Statement 8: The method of Statement 7, wherein the parsing step identifies JSON structures, arrays, nested objects, and simple data values within the API response.

Statement 9: The method of Statement 7 or 8, wherein the registering step comprises creating a structured representation of the API response data for analysis and comparison.

Statement 10: The method of Statement 7, 8 or 9, further comprising integrating the normalized API response data with incident response systems for automated incident management.

Statement 11: The method of any one of Statements 6 to 10 comprising performing error handling and error reporting in accordance with the API request and either the API response or absence of the API response.

Statement 12: The method of any one of Statements 1 to 11, comprising providing an interface with which to define at least some of the test scenario instances and at least some of the instances of test scenario data; receiving input via the interface; and defining the at least some of the test scenario instances and at least some of the instances of test scenario data.

Statement 13: The method of Statement 12 comprising processing the input using a generative artificial intelligence based large language model configured to process input comprising business requirements, API definitions, and metadata and/or database schema examples to generate at least one test scenario instance and test scenario data associated therewith.

Statement 14: A test computing system comprising at least one processor and at least one storage device storing instructions that when executed by the at least one processor cause the computing system to automate testing of a target computing system having one or more application programming interfaces (APIs) for interacting with the target computing system, the instructions as executed cause the test computing system to: store a plurality of test scenario instances to a database, the test scenario instances comprising metadata with which to define API requests to communicate to the computing system to test the target computing system by simulating a use scenario therefor, each API request comprising an API request payload including test scenario data in accordance with the use scenario; store a plurality of test scenario data for use as instances of test scenario data for instances of API requests; retrieve, from the database, metadata of a test scenario instance and an instance of test scenario data responsive to the use scenario to be tested; generate the API request and the API request payload dynamically based on the metadata and instance of the test scenario data; allocate unique identifiers within the API request payload for chaining multiple API requests based on the metadata; and communicate the API request with the API request payload to the target computing system to obtain an API response comprising an API response payload.

Statement 15: The test computing system of Statement 14, wherein the instance of test scenario data retrieved comprises one or more of a fixed data element or a dynamically generated data element.

Statement 16: The test computing system of Statement 14 to 15, wherein the instance of test scenario data retrieved includes session data, API instructions, JSON structures, numeric values, or Boolean values, or combinations thereof.

Statement 17: The test computing system of any one of Statements 14 to 16, wherein the unique identifiers within the API request payload enable chaining of multiple API requests by referencing previous API response data from previous API response payloads.

Statement 18: The test computing system of any one of Statements 14 to 17, wherein the instructions as executed cause the test computing system to iterate through the multiple API requests in accordance with the metadata and API responses received in the chain.

Statement 19: The test computing system of any one of Statements 14 to 18, wherein the instructions as executed cause the test computing system to receive the API response in response to the API request; storing the API reply to the database.

Statement 20: The test computing system of Statement 19, wherein the instructions as executed cause the test computing system to: parse the API response to identify data elements of the API response payload; register the identified data elements in a normalized fashion; and store the normalized API response data in the database.

Statement 21: The test computing system of Statement 20, wherein to parse identifies JSON structures, arrays, nested objects, and simple data values within the API response.

Statement 22: The test computing system of Statement 20 or 21, wherein to register comprises creating a structured representation of the API response data for analysis and comparison.

Statement 23: The test computing system of Statement 20, 21 or 22, wherein the instructions as executed cause the test computing system to integrate the normalized API response data with incident response systems for automated incident management.

Statement 24: The test computing system of any one of Statements 29 to 23, wherein the instructions as executed cause the test computing system to perform error handling and error reporting in accordance with the API request and either the API response or absence of the API response.

Statement 25: The test computing system of any one of Statements 14 to 24, wherein the instructions as executed cause the test computing system to: provide an interface with which to define at least some of the test scenario instances and at least some of the instances of test scenario data; receive input via the interface; and define the at least some of the test scenario instances and at least some of the instances of test scenario data.

Statement 26: The test computing system of Statement 25, wherein the instructions as executed cause the test computing system to: process the input using a generative artificial intelligence based large language model configured to process input comprising business requirements, API definitions, and metadata and/or database schema examples to generate at least one test scenario instance and test scenario data associated therewith.

These and other aspects will be apparent including computer program product aspects where such product comprises at least one storage device storing instructions that when executed by at least one processor cause the at least one processor (e.g. of a test computing system or device) to perform a method according to any one of the numbered statements to a method.

### BRIEF DESCRIPTION OF DRAWINGS

FIG. 1 is a diagram of an exemplary computing environment, consistent with disclosed embodiments.

FIGS. 2A, 2B and 2C are flow charts of operations, consistent with disclosed embodiments.

FIG. 3 is a diagram of a further exemplary computing environment, consistent with disclosed embodiments.

FIG. 4 is a flowchart of operations of a computing system in accordance with an embodiment.

### DETAILED DESCRIPTION

The disclosed embodiments provide a comprehensive solution for addressing several issues. Embodiments may comprise methods and apparatus aspects such as a computing system having one or more processors and one or more storage devices, for example, where instructions are stored that when executed by the one ore more processors cause the computing system to perform operations or steps of a method aspect. Apparatus (e.g. a computer program product) comprising a non-transient storage device can store executable instructions that when executed so configure a computing system. While the disclosure herein may focus on method embodiments and/or aspects, it will be understood that apparatus aspects and embodiments are included.

In accordance with a method aspect, the method facilitates dynamic and data-driven API request generation. The method adapts to different API endpoints and structures, allowing users to define requests based on metadata and input parameters. The method (and a system so configured) can intelligently chain requests together, creating a seamless end-to-end testing process.

In conjunction with request generation, the method can normalize API responses into a consistent format. Regardless of the complexity or structure of the responses, this method can store data uniformly. In an embodiment, the normalized responses simplify subsequent data analysis, comparison, and anomaly detection.

By combining request generation and response handling, in an embodiment, the method offers a complete end-to-end solution for automated API testing and integration. The method can be suitable for a wide range of scenarios, from simple API interactions to complex multi-step workflows.

In accordance with embodiments, numerous advantages can be provided, including one or more of the following:

Streamlined API Testing: Data-driven request generation simplifies the testing process, making it accessible to users with varying levels of technical expertise.

Consistent Data Handling: Normalized responses improve data quality, enabling meaningful analysis and anomaly detection.

End-to-End Automation: The system enables automated end-to-end testing and integration, reducing manual effort and human error.

Metadata-Driven Adaptability: Metadata-driven programming ensures that the system can adapt to changing APIs and requirements seamlessly.

Error Handling: Robust error handling mechanisms are implemented to maintain data integrity during the testing and integration process. Errors or exceptions are appropriately managed to ensure reliable results.

Integration: The method can seamlessly integrate with other operations of components of a data processing pipeline, enhancing the overall efficiency of data-driven workflows.

Reusability: The method's modular design and metadata-driven approach make it highly reusable. It can be applied to various API endpoints and scenarios, offering a cost-effective solution for automated testing and integration.

### Exemplary Computing Environments

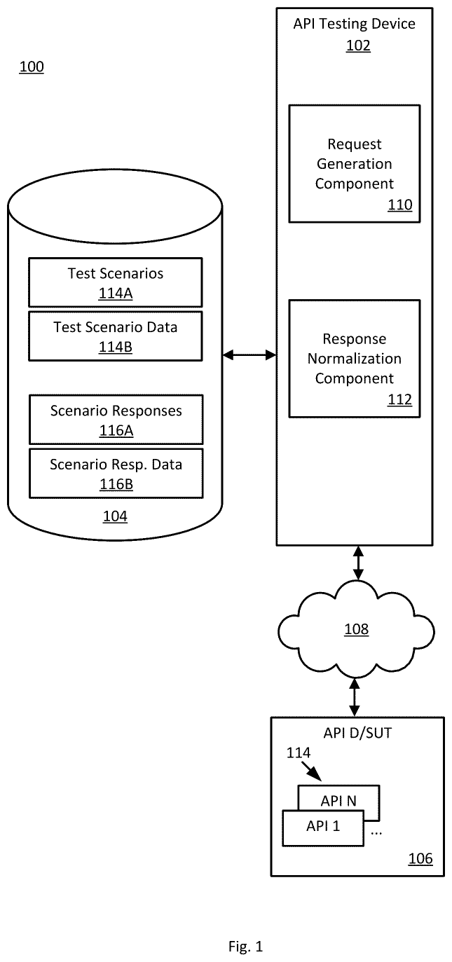

FIG. 1 is a diagram of an exemplary computing environment, consistent with disclosed embodiments.

As illustrated in FIG. 1, environment 100 may include a computing device providing an API testing device 102, a database 104, or other data store and an API device or system under test (D/SUT) 106. API D/SUT 106 and API testing device 102 are coupled via a communication network 108. The environment 100 is simplified for clarity of illustration and brevity. For example, components are not illustrated for devices/systems 102, 104 and 106, such as communication interfaces, operating systems, user interfaces, etc.

API testing device 102 is configured to execute API testing of API D/SUT 106. In an embodiment, API testing device 102 comprises a request generation component 110 to prepare and communicate API requests. API testing device 102 further comprises a request normalization component 112 to receive API responses and to process same for storing in a normalized form to database 104.

Any of the computing devices herein including API testing device 102 or API D/SUT comprises a server, desktop, laptop, workstation or other computing device and, can comprise more than one computing device such as a plurality of servers, etc.

Though not illustrated, per se, a computing device can comprise one or more processors (e.g. CPU, a GPU, etc.), one or more storage devices, input devices (a keyboard, a pointing device, a touch pad, a microphone), output devices (a display screen, a light, a projector, a speaker, a bell, etc.) and/or input/output devices (e.g. touch screen, etc.). The one or more storage devices can store instructions that are computer readable and executable such as by the one or more processors such that they cause the computing device to perform certain operations or steps.

A storage device may comprise a machine-readable medium that includes any mechanism for storing or transmitting information in a form (e.g., software, processing application) readable by a machine (e.g., a computer). Such media may take the form of, but is not limited to, non-volatile media and volatile media. Non-volatile media includes optical or magnetic disks. Volatile media includes dynamic memory, such as main memory. Common forms of machine-readable medium may include, but is not limited to, magnetic storage medium; optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions (e.g. a computer program). A computer program may be implemented in any programming language, such as a high-level procedural programming language, an object-oriented programming language, an assembly language or machine language, etc. Programming languages may, for example, be compiled or interpreted for execution.

Any of the foregoing may be supplemented by, or incorporated in, specially-designed ASICs (application-specific integrated circuits) or FPGAs (Field-Programmable Gate Arrays).

In an embodiment, request generation component 110 and request normalization component 112 (and respective operations thereof) are configured using instructions. Similarly, operations of database 104 and API D/SUT 106 are configured via respective instructions.

As further described herein below, database 104 stores test scenarios 114A and test scenario data 114B for generating instances of API requests with which to test API D/SUT 106. Database 104 stores scenario responses 116A and scenario response data 114B from instances of response received from the instances of API requests. In an embodiment, tables are employed to store such data.

In an embodiment, API D/SUT 106 comprises one or more (e.g. N) APIs (e.g. API-1 . . . . API-N) to be tested. Broadly an API provides access to a resource using a method at an API endpoint. An API endpoint can comprise a digital location for receiving requests about a specific resource (e.g. on its server). In an embodiment, an endpoint comprises a uniform resource locator (URL) that provides the location of a resource on the server. A method (e.g. a hypertext transfer protocol- (HTTP-) type method like GET or POST, etc.) defines the action for performing on the resource.

Though illustrated as a single component, API D/SUT can comprise multiple separate devices including separately distributed devices. Examples of an API D/SUT include, without limitation, an e-commerce website, a financial system for consumer banking, a restaurant reservation system, an Internet of Things (IoT)-based system monitoring energy related information for an energy grid, a document management system, a health care management system for hospitals and practitioners, etc.

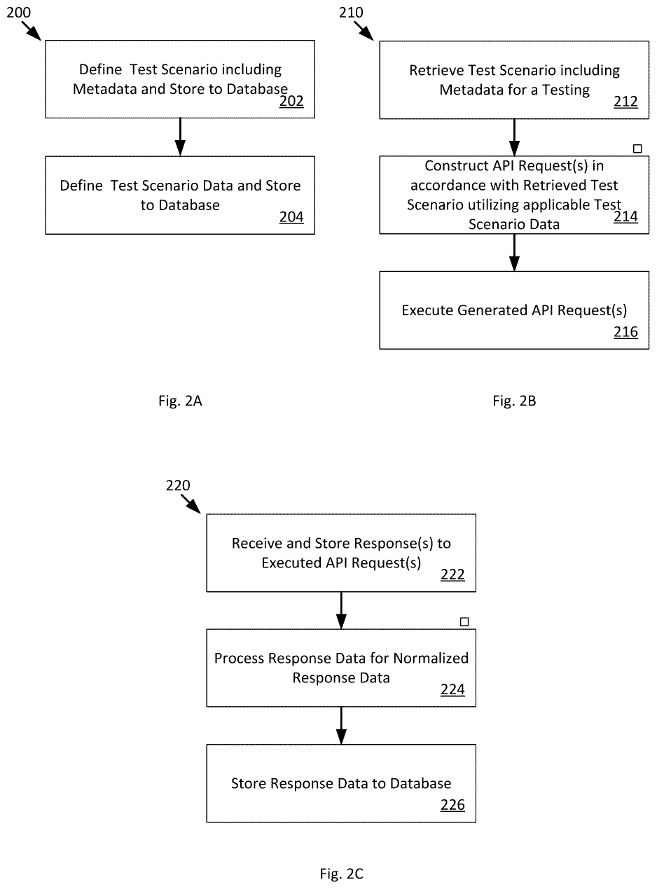

FIG. 1 can be understood with reference to FIGS. 2A, 2B and 2C showing operations 200, 210 and 220 thereof, in accordance with an embodiment. API testing device 102 is configured to execute API testing by employing a data-driven API request generation approach. Operations 200, 210 and 220 relate to defining a test scenario and its data for API requests, request generation and execution using the defined scenario and data, and receiving and handling response to API requests.

Turning to FIG. 2A and operations 200, at block 202, metadata is defined that describes the API endpoints, request parameters, and their relationships. In an embodiment, the metadata definition is data driven. The metadata is stored to database 104 as a test scenario (e.g. instance of 114A), providing a definition for use to generate instances of API requests to the API endpoint(s) associated with the metadata. In an embodiment, a test scenario can include metadata to interact with several APIs.

Metadata specifies information such as endpoint URLs, HTTP methods (e.g., GET, POST), input parameters, and expected response structures. Metadata may be defined using various markup or other languages, for example, including script, Structured Query Language (SQL), etc.

At block 204, operations define test scenario data (e.g. instance(s) of 114B) and store to database 104. Examples of test data for scenarios are shown further below. Instances of test scenario data can comprises one or more of a fixed data element or a dynamically generated data element (e.g. elements of each). Instances of test scenario data can include session data, API instructions, JSON structures, numeric values, or Boolean values, or combinations thereof.

Turning to FIG. 2B and operations 210, at block 212, for example, once all definitions of test scenario and data are completed and stored and the API D/SUT 106 is available for testing, request generation component 110 establishes a connection to database 104. Request generation component 110 retrieves a test scenario instance (e.g. 114A) including its metadata related to the desired API scenario, including endpoint details and input parameters.

In an embodiment, operations at 210 extract information from the test scenario data table (instance of 116B), which contains specific field-name and field-value pairs used in building the API request. Additionally, within this table, mechanisms can flag (identify) certain fields for specific purposes such as: (i) fields can be flagged to be mapped to a session variable, allowing dynamic assignment from the API's data sources; or (ii) fields can be flagged as dependencies pulled from foreign keys associated with other endpoints defined elsewhere in the system.

In an example, an endpoint API may utilize an identifier relevant in API D/SUT 106. To obtain that identifier, a call (e.g. a request) to a dependent API is made to pull the data for another (e.g. a current) API call so that such another call can locate the relevant resource specific for the context of that call. In a context of an energy use monitoring system where APIs provide meter usage data, to call an API for meter data a dependent API call can be made to obtain a meter data identifier that can be use to call the meter data API. Thus, a system may have more than one API to which one API call is needed to get the identifiers to call their other API they provide.

This flexibility in field handling enables dynamic and context-aware API request construction. In an embodiment, test scenarios are defined to interact with a system presenting typically a plurality of APIs, where the scenarios selectively call each API according to the properties each provides. In an embodiment, and in accordance with the particular system (endpoint) under test, a test scenario has its own session context. Operations (e.g. of API testing device 102) persist session related information so that it can continue interacting with the API D/SUT 106 (e.g. a server) in continuity using the session variables.

At block 214, in accordance with the retrieved test scenario, and utilizing applicable test scenario data 114B retrieved from database 104 and/or dynamically generated as is applicable, request generation component 110 dynamically constructs one or more API requests. In an example, depending on the defined properties, this step handles various types of requests, including POST and various GET structures (e.g., name-value pairs and path parameters).

In an embodiment, request generation component 110 can extract a test scenario's metadata from database 104. Based on the sequence of the extraction, for example, request generation component 110 determines how to prepare and iterate through each call, by reading the metadata to know how to conduct its interaction with API D/SUT 106 as the metadata closely aligns with the external system's API properties and requirements. Each API is well-defined and thus scenarios and related testing data to call an API can be defined accordingly. Testing can be exhaustive in nature, for example, based on any number of metadata entries that correlate to each of the API, and also based on the number of test accounts calling those API. Test accounts are simulated user accounts with which to interact with the API D/SUT 106 and that device 106 can be configured accordingly with respective simulated user account information. In an embodiment, there are 100 API provided by API D/SUT 106 and there at 5 test accounts. Applicable test scenarios to test each API for each test account are defined. Request generation component 110 rolls through each scenario to interact with the 100 APIs, calling for each of the 5 accounts, making e.g. 500 calls in total. In an embodiment, each test scenario is based on patterns of properties for which each API is designed (always standard as per the API definitions) and the responses for which each API is designed to provide (responses by code and always standard as per the API definitions).

In applicable instances where session and/or foreign keys are required, API testing device 102 utilizes a chaining mechanism for handling dependencies between requests. Broadly herein, chaining means the output of one process can be the input of another process and a changing mechanism facilitates this relationship. For example, when a request to a login API is made, login credentials are passed, and the successful output of login API is a session. Session-related information is persisted to database 104 so that further API calls can be made, chaining calls accordingly. For any portal related API that requires login to be successful, the session is used and those portal API called to pass session data thus allowing request generation component 110 to automatically continue the interaction with the API D/SUT 106, and thus chaining is extended. For a particular API that utilizes an identifier to locate a specific resource, an account-related API, for example, can be called to locate the resource. In an energy monitoring environment an account may be associated with one or more meters having meter data. A further API call can pull the meter identifier from that list and use that meter identifier from that call as the output to chain a further call to a subsequent API that may be specific to a meter.

At block 216, request generation component 110 executes the one or more generated API requests. The API requests are communicated to API D/SUT 106 for processing. As noted, such one or more requests may simulate execution of various scenarios, from simple single-step requests to complex multi-step workflows.

In an embodiment, request generation component 110 iterates through the stored test scenarios and calls each API per the scenario. Response codes and data are persisted to database 104. For example, HTTP has consistent response codes, such as provided by HTTP's protocol definition, or otherwise defined. Multi-step workflows can be incorporated by chaining API calls together by looking at the expected outcome of those API codes and/or looking at data responses from each API to which that output can be used as input for the next stage of the flow. In an embodiment, response monitoring works to ensure the test scenario conforms to the API requirements. For example, monitoring may prevent or control a chained API to initiate unless it has all of its dependencies available to it to be able to initiate it's call. Monitoring can correlate the output to the necessary input to make a successful call. And if those inputs are not available, the monitoring can block further processing. Workflows are successful only when it has all the necessary information to flow through.

In an embodiment, test scenarios can be defined and executed to simulate user behaviour to interact with the API D/SUT 106, for example, simulating a user using a browser to interact with the APIs. Browser session related data, cookies, etc. are stored do the data base 104 and provided in APO calls to facilitate the testing. Test scenarios and execution can: perform recursive retrieval of session and foreign keys for parent endpoint properties (including chained dependencies); address the complexity of chained dependencies, where one endpoint definition in the data can have references to other endpoints, creating a chain of dependencies. Ensure that foreign keys required as dependencies for an API are gathered effectively, allowing for the precise retrieval of data slices. Thus operations can dynamically assign session variables based on API response data, providing flexibility and adaptability in constructing API requests with accurate dependencies and session-related data.

Turning to FIG. 2C and operations 220, at block 222, for example, operations receive and store the response(s) for the one or more API requests that were executed. Raw responses (e.g. unprocessed) are stored as instances of 116A to database 104 in an embodiment for further processing, along with status and/or status codes such as in accordance with restful API practices, which codes are known to persons of ordinary skill in the art.

At block 224, operations process each response in accordance with a normalized generic response handling. For example, the one or more API responses are retrieved. The data is processed (e.g. normalized) to define the data into a consistent data structure, in accordance with response processing configuration that accommodates responses of different structures and complexities. The normalized data is defined to contain selected information allowing for meaningful test analysis and comparison.

A response may include nested data in a plurality of payloads, for example, which may be nested at one or more (e.g. k) levels (1 . . . k). The respective data at each level is recursively unpacked for normalizing the API response payload.

At block 226, response data (e.g. from each level 1 to k) is stored to database 104 (e.g. instances of 116B). Storing, in an embodiment, may comprise establishing a mechanism to register normalized API responses into database 140, where the registration process maintains data integrity and prevents data loss during high-throughput operations.

Functions and features may be further understood from the following example that illustrates chaining API calls with session tokens and identifiers. In the following example, the test scenario simulates a user interacting with a set of APIs under test where the user is using a browser. Examples as provided include script, SQL DDL (data definition language) and/or or other instructions for a computer.

### Overview

### Session Initialization:

A login API is called to obtain a session token. This session token is stored and used for subsequent API calls.

### Dynamic Identifier Resolution:

APIs that require dynamic data or identifiers from previous API responses have entries in the test scenario data 104B table with a field_type of ‘api’. In an embodiment, these entries contain formatting instructions, such as using JSON, on how to retrieve the necessary data from another API response. As noted in Wikipedia®, “JSON (JavaScript Object Notation, . . . ) is an open standard file format and data interchange format that uses human-readable text to store and transmit data objects consisting of attribute-value pairs and arrays (or other serializable values).”

### API Call Execution:

The API testing device 102 dynamically constructs and executes API calls using the applicable definitions, and the session tokens and identifiers obtained from previous API responses such as retrieved from database 104.

### Step-by-Step Example

### Session Initialization (Login):

```
private static bool ResolveAPIAssignAccessToken(ILogger log, string eventType, string
    accountType)
{
  bool sessionSet = false;
  try
  {
    dynamic apiEndpoint = GetScenarioByAccountTypeForLogin(log, eventType, accountType,
    “Auth”);
    string scenario = apiEndpoint.scenario;
    string endpointUrl = apiEndpoint.url;
    string method = apiEndpoint.requestMethod;
    string data = GetTestPayload(log, method, scenario, “”, accountType);
    HttpResponseMessage response = CallApi(log, endpointUrl, method, data, false,
    accountType);
    dynamic parsedResponse = JsonConvert.DeserializeObject(ReadResponseContent(log,
    response));
    ParseResponseAccess Token(log, parsedResponse, accountType);
    ResolveUserAccountToken(log, accountType);
    if (!string.IsNullOrEmpty(Globals.sessionData[accountType].accountNumber)) {
      sessionSet = true;
    }
  }
  catch (Exception ex)
  {
    log.LogInformation(“Cannot execute ResolveAPIAssignAccessToken: ” + ex.ToString( ));
  }
  return sessionSet;
}
```

Dynamic Identifier Resolution (Using Field Type ‘api’): The GetTestPayload method resolves dynamic data:

```
private static string GetTestPayload(ILogger log, string method, string scenario, string
    matchFieldName, string accountType)
{
  string dbConfig = Globals.BYODKEY;
  var dynamicEntriesDict = new Dictionary<string, object>( );
  const string storedProcedureName = “select_iat_test_scenario_data”;
  using (var sqlConnection = new SqlConnection(dbConfig))
  {
    sqlConnection.Open( );
    using (var cmd = new SqlCommand(storedProcedureName, sqlConnection))
    {
      cmd.CommandType = CommandType.StoredProcedure;
      cmd.Parameters.AddWithValue(“@scenario”, scenario);
      using (var reader = cmd.ExecuteReader( ))
      {
        while (reader.Read( ))
        {
          string fieldName = reader.GetString(reader.GetOrdinal(“field_name”));
          string fieldType = reader.GetString(reader.GetOrdinal(“field_type”));
          if (fieldType == “api”)
          {
            string dataAPI_instruction = reader.GetString(reader.GetOrdinal(“field_value”));
            string dataTokenValue = ResolveAPIDataToken(log, dataAPI_instruction,
    accountType);
            dynamicEntriesDict.Add(fieldName, dataTokenValue);
          }
          else
          {
            // Handle other field types...
          }
        }
      }
    }
  }
  return JsonConvert.SerializeObject(dynamicEntriesDict);
}
```

Resolve Data Token from Another API: the ResolveAPIDataToken method retrieves data from another API based on instructions stored in test scenario data 104B (e.g. labelled “iat_test_scenario_data”):

```
private static string ResolveAPIDataToken(ILogger log, string payloadInstructions, string
    accountType)
{
  string dataTokenResult = “”;
  try
  {
    PayloadInstructions endPointPayload =
    JsonConvert.DeserializeObject<PayloadInstructions>(payloadInstructions);
    dynamic apiEndpoint = GetScenarioEntriesByScenario(log, endPointPayload.scenario);
    string endpointUrl = apiEndpoint.url;
    string method = apiEndpoint.requestMethod;
    string data = GetTestPayload(log, method, apiEndpoint.scenario, “”, accountType);
    HttpResponseMessage response = CallApi(log, endpointUrl, method, data, false,
    accountType);
    dynamic parsedResponse = JsonConvert.DeserializeObject(ReadResponseContent(log,
    response));
    if (parsedResponse != null && parsedResponse.ContainsKey(“data”))
    {
      var dataToken = parsedResponse[“data”];
      JArray trunkArray = (dataToken is JArray) ? (JArray)dataToken : new JArray( );
      foreach (var dataObject in trunkArray.Children<JObject>( ))
      {
        if (endPointPayload.qualifiers.All(q => dataObject[q.Key]?.ToString( ) == q.Value))
        {
          dataTokenResult = dataObject[endPointPayload.target]?.ToString( ) ?? “”;
          break;
        }
      }
    }
  }
  catch (Exception ex)
  {
    log.LogInformation(“Cannot execute ResolveAPIDataToken: ” + ex.ToString( ));
  }
  return dataTokenResult;
}
```

Using Resolved Data in API Calls: The resolved data token is then used as an input for another API call. This chaining mechanism allows for complex end-to-end testing scenarios where the output of one API becomes the input for another.

```
private static void GeneratePayloadCallAPIPersistReponse(ILogger log, dynamic apiEndpoint, string
    testFieldName)
{
  try
  {
    string data = GetTestPayload(log, apiEndpoint.requestMethod, apiEndpoint.scenario,
    testFieldName, apiEndpoint.accountType);
    HttpResponseMessage response = CallApi(log, apiEndpoint.url, apiEndpoint.requestMethod,
    data, false, apiEndpoint.accountType);
    string responseContent = ReadResponseContent(log, response);
    dynamic parsedResponse = JsonConvert.DeserializeObject(responseContent);
    if (response.IsSuccessStatusCode)
    {
      PersistResult(log, parsedResponse, apiEndpoint);
    }
    else
    {
      PersistFailure(log, parsedResponse, apiEndpoint);
    }
  }
  catch (Exception ex)
  {
    log.LogInformation(“Cannot execute GeneratePayloadCallAPIPersistReponse: ” +
  ex.ToString( ));
  }
}
```

By leveraging the field_type of ‘api’, API testing device 102 can dynamically resolve and reuse data from previous API calls. This approach assists the end-to-end testing framework provided by API testing device 102 to handle complex scenarios involving multiple interconnected APIs, making implementation highly robust and flexible.

Example DDL Entries in test scenario data 104B: consider the following DDL entries in the test scenario data 104B:

```
INSERT INTO iat_test_scenario_data (scenario, field_name, field_value, field_type, field_context)
VALUES
(‘Scenario1’, ‘access Token’, ‘sessionData’, ‘session’, ‘accessToken’),
(‘Scenario1’, ‘userld’, ‘{“scenario”:“LoginAPI”, “root”:“data”, “structure”:“array”, “trunk”:“users”,
  “qualifiers”:{“role”:“admin”}, “target”:“id”}’, ‘api’, ‘userId’),
(‘Scenario1’, ‘accountld’, ‘{“scenario”:“GetAccountsAPI”, “root”:“data”, “structure”:“array”,
  “trunk”:“accounts”, “qualifiers”:{“type”:“primary”}, “target”:“accountNumber”}’, ‘api’, ‘accountld’);
```

### Explanation of the DDL Entries:

```
accessToken:
  field_name: accessToken
  field_value: sessionData
  field_type: session
  field_context: accessToken
```

This entry specifies that the accessToken should be fetched from the session data.

```
userId:
  field_name: userId
  field_value: JSON object specifying how to resolve the userld from the response of LoginAPI.
  field_type: api
  field_context: userId
```

This entry indicates that the userId should be resolved by calling the LoginAPI, navigating through the JSON response to the users array, and finding the id of the user with the role admin.

```
accountId:
  field_name: accountId
  field_value: JSON object specifying how to resolve the accountld from the response of
    GetAccountsAPI.
  field_type: api
  field_context: accountId
```

This entry indicates that the accountId should be resolved by calling the GetAccountsAPI, navigating through the JSON response to the accounts array, and finding the accountNumber of the account with the type primary.

How the DDL Entries Drive the Process: 1) Fetching the Session Token: The ResolveAPIAssignAccess Token method logs in and fetches the access Token, storing it in the session; 2) Resolving the userId: When building the payload for Scenario1, the GetTestPayload method identifies the userId field with a field_type of ‘api’. It calls ResolveAPIDataToken with the JSON instructions to fetch the userId from the LoginAPI response; 3) Resolving the accountId: Similarly, the GetTestPayload method identifies the accountId field with a field_type of ‘api’. It calls ResolveAPIDataToken with the JSON instructions to fetch the accountId from the GetAccountsAPI response.

By defining the field_type as ‘api’ and providing JSON instructions in the field_value, the system dynamically chains API calls, fetching necessary identifiers from previous API responses. This allows for a highly flexible and automated end-to-end testing framework.

Further features are shown in the following examples based on stored procedures and code, in accordance with an embodiment:

Dynamic API Call Handling: The ProcessApiEndpoint method dynamically processes multiple API endpoints by iterating through predefined test scenarios, making it highly flexible for end-to-end testing of various APIs. Example script is provided in accordance with an embodiment:
private static int ProcessApiEndpoint(ILogger log, dynamic apiEndpoint, int sleepTime, int inserted)

```
  {
  try {
    string scenario = apiEndpoint.scenario;
    string pattern = apiEndpoint.pattern;
    string requestEvent = apiEndpoint.requestEvent;
    string accountType = apiEndpoint.accountType;
    List<string> testList = GetTestlterations(log, scenario);
    foreach (string testFieldName in testList) {
      GeneratePayloadCallAPIPersistReponse(log, apiEndpoint, testFieldName);
      Thread.Sleep(sleepTime); // We Pause so that the endpoint doesn't block our IP
      inserted++;
    }
    log.Log Information(“ProcessApiEndpoint: executed ” + scenario + “...” + pattern + “... inserted:
  ” + inserted);
  } catch (Exception ex) {
    log.Log Information(“Cannot execute ProcessApiEndpoint: ” + ex.ToString( ));
  }
  return inserted;
}
```

Dynamic SQL Execution: The insert_fault_expectation_rules_engine stored procedure dynamically constructs SQL queries to handle fault logging, demonstrating advanced SQL and T-SQL capabilities. Example code is provided in accordance with an embodiment, where iat_scenario_response and iat_scenario_response_data are labels for scenario responses 116A and scenario response data 116B:

```
  CREATE PROCEDURE insert_fault_expectation_rules_engine
    @Scenario nvarchar(100),
    @Expectation nvarchar(150),
    @SourceType nvarchar(100),
    @SourceColumn nvarchar(100),
    @SourceData nvarchar(100),
    @TargetType nvarchar(100),
    @TargetColumn nvarchar(100),
    @TargetData nvarchar(100),
    @ConditionData nvarchar(100),
    @Qualifier nvarchar(100)
  AS
  BEGIN
    -- Dynamic SQL generation and execution
    DECLARE @sql nvarchar(max);
    DECLARE @SourceTableName nvarchar(128), @TargetTableName nvarchar(128);
    SELECT @SourceTableName =
      CASE @Source Type
        WHEN ‘response’ THEN ‘iat_scenario_response’
        WHEN ‘response_data’ THEN ‘iat_scenario_response_data’
        ELSE NULL
      END,
    @TargetTableName =
      CASE @TargetType
        WHEN ‘response’ THEN ‘iat_scenario_response’
        WHEN ‘response_data’ THEN ‘iat_scenario_response_data’
        ELSE NULL
      END;
    IF (@TargetType = “ OR @TargetColumn = ” OR @TargetData = ”)
    BEGIN
      SET @sql = N‘INSERT INTO iat_fault_log (scenario, expectation, test_result_id) ’ +
        ‘ SELECT @ScenarioParam, @ExpectationParam, stn.test_result_id FROM ’ +
      QUOTENAME(@SourceTableName) + ‘ stn ’ +
        ‘ WHERE ’ + QUOTENAME(@SourceColumn) + ‘ <> @SourceDataParam’ +
        ‘ AND NOT EXISTS ( ’ +
        ‘ SELECT 1 FROM iat_fault_log ifl WHERE ifl.scenario = stn.scenario AND ifl.test_result_id
      = stn.test_result_id ’ +
        ‘ ) ’;
    END
    ELSE
    BEGIN
      SET @sql = N‘INSERT INTO iat_fault_log (scenario, expectation, test_result_id) ’ +
        ‘ SELECT @ScenarioParam, @ExpectationParam, stn.test_result id FROM ’ +
      QUOTENAME(@SourceTableName) + ‘ stn ’ +
        ‘ WHERE ’ + QUOTENAME(@SourceColumn) + ‘ = @SourceDataParam’ +
        ‘ AND ’ + QUOTENAME(@TargetColumn) + ‘ <> @TargetDataParam’ +
        ‘ AND NOT EXISTS ( ’ +
        ‘ SELECT 1 FROM iat_fault_log ifl WHERE ifl.scenario = stn.scenario AND ifl.test_result_id
      = stn.test_result_id ’ +
        ‘ ) ’;
    END
    DECLARE @params nvarchar(max) = N‘@Source DataParam nvarchar(100),
    @TargetDataParam nvarchar(100), @ScenarioParam nvarchar(100), @ExpectationParam
    nvarchar(150)’;
    EXEC sp_executesql @sql, @params,
      @SourceDataParam = @SourceData, @TargetDataParam = @TargetData,
      @ScenarioParam = @Scenario, @ExpectationParam = @Expectation;
  END
```

Automated Test Execution and Evaluation: The EvaluateExpectations method automates the evaluation of test expectations against predefined rules, integrating with the iat_evaluate_rules_engine stored procedure. Example script is provided in accordance with an embodiment:

```
private static void EvaluateExpectations(ILogger log) {
  List<string> logMessages = new List<string>( );
  logMessages.Add(“Evaluated Expectations”);
  standAloneStoredProcedure(log, “iat_evaluate_rules_engine”);
  log.LogInformation(string.Join(Environment.NewLine, logMessages));
}
```

End-to-End Automation with Azure Functions: The Run method of the Azure Function orchestrates the entire process, showcasing the integration of various components for end-to-end testing. Example script is provided in accordance with an embodiment:

```
public static void Run(TimerInfo myTimer, ILogger log)
{
  Stopwatch stopwatch = new Stopwatch( );
  stopwatch.Start( );
  QueueScenarios(log);
  ExecuteTestScenarios(log);
  EvaluateExpectations(log);
  stopwatch.Stop( );
  TimeSpan trackingTime = stopwatch.Elapsed;
  insertAutomationTracking(log, trackingTime);
}
```

These examples illustrate the sophisticated approach taken to automate API testing and evaluation using a combination of serverless computing functions (e.g. Azure® Functions) for event-driven code execution, dynamic SQL execution, and extensive logging and tracking mechanisms, in accordance with an embodiment.

Metadata-Driven Programming in accordance with embodiments herein showcases features including: Metadata Management: There is provided a system for creating, storing, and managing metadata that is accessible and modifiable as requirements evolve. System users are enabled to define metadata that governs the behavior of the system, including request generation and response handling; Adaptability: The system's functionality is driven by the provided metadata and can adapt to changes in API structures, endpoints, and requirements seamlessly; Error Handling: Robust error handling mechanisms gracefully manage errors or exceptions during the testing and integration process. Errors are logged and reported accurately. Reusability: The system is designed with modularity and reusability in mind. Components related to request generation, response handling, and metadata management are adaptable to various API scenarios and endpoints. Integration: Consider how the system can integrate with other components of a data processing pipeline. Ensure that it can be seamlessly incorporated into existing data-driven workflows.

Metadata-driven programming enables registering an API in a way where states from the data can be designated instead of using hard-wiring or hard coding. With that, adaptability is achieved in that the intended behavior is designated in data and the related code is previously constructed and tested to handle such conditions. Likewise, for error handling, there are provide defaults and pre-defined conditions that can be designate to operate based on how the API is registered in the data.

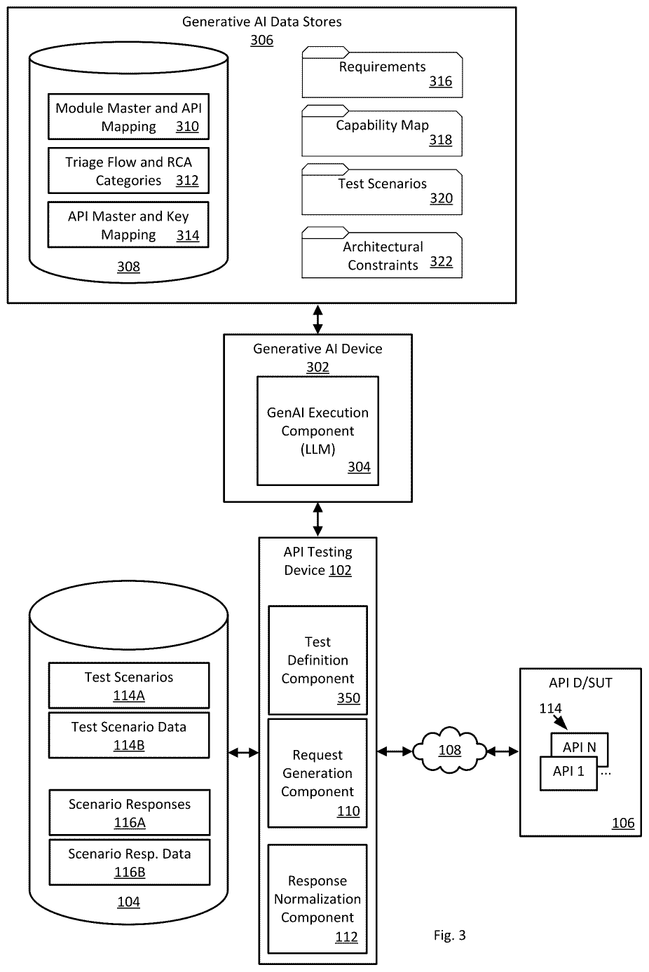

FIG. 3 shows a further environment 300 consistent with at least some embodiments herein. Environment 300 shows components of environment 100 and further comprises a generative AI (GenAI) device 302 (an example of a computing device) having a GenAI execution component 304 (comprising a trained large language model (LLM)) and a GenAI data store 306. In an embodiment, data store 306 comprises various stores of data, including a database 308. In an embodiment, database 308 stores module master and API mapping data 310, triage flow and RCA categories 312, and API master and key mapping data 314. These may be tables. There is further stored (e.g. as a file document) requirements data 316, capability map data 318, test scenarios 320 and architectural constraints 322. In an embodiment, API testing device 102 comprises a test definition component, for example, to provide one or more user interfaces 350 configured to receive input for defining test scenario instances and instances of test scenario data for such instances. Input can comprise business requirements and API definitions, metadata and/or database schema (definitions), examples of scenarios and scenario data, etc. to define components of a test to store to database 104.

In an embodiment API testing device 102 is configured to communicate with Gen AI device 302, for example, to have generated at least some test scenario instances and instances test scenario data for such instances. API testing device 102 is configured to provide input to GenAI device 302 including business requirements, API definitions, metadata and database schema (definitions), examples for test scenario instances and instances test scenario data.

In an embodiment, an LLM such as ChatGPT™ (a trademark of OpenAI) is presented with business requirements definitions, API documentation, data definition schema and queried to obtain output. In an embodiment, interaction with ChatGPT is performed using prompts and a publicly available API in accordance with its publicly available service. The LLM processes the inputs (e.g. requirements and documentation, schema) using its trained understanding of language and determines correlations between the requirements and documentation, providing output responsive to the prompt and according to the schema.

GenAI. GenAI Synthesis is achievable by correlating disparate items, such as business requirements and API documentation, in a way that learns if a particular correlation is more or less relevant than another. GenAI Synthesis is configured to take, as an example, the external system API documentation, correlate that to the business requirements, and match up which requirement would most likely be important for a set of the external system API to participate. API testing scenarios will interact with those API to evaluate whether the requirement is successful. Thus, in context of this disclosure, GenAI Synthesis is useful to correlate the API documentation with the requirement documentation, and to determine an understanding that the requirement can be tested using a scenario that interacts with the API. Further it is useful to define and register the scenario and the API map e.g. as meta data needed to operate in the tool to conduct 110 and 112.

Requirement issues can comprise those that are common or generic among various projects having computer implement systems and those that maybe specific to a particular project. For example, common issues can comprise system down or customer data not there or meter data not available (e.g. in a meter reading scenario). A business requirements document can set out a requirement in a way that aligns with the target objectives of the requirement. For example, there can be a requirement for a user to list it's meters. The text of this requirement that a user wants to list their meters is correlated or associated with (e.g. by the LLM finding) an API called “Meter List” or “Meters” or “GetMeter”. The LLM has trained knowledge from the API documentation and its understanding of language to “know” the purposes, etc. of the available APIs for the project.

Also with other aspects like capabilities, a correlation of the applicable text of a (desired project) capability to the bed of relevant API can be made to determine the applicable APIs that meet the desired capability. Operations to correlate requirements including desired capability, goals and objectives can be performed for each to determine the applicable APIs (and applicable combinations thereof). All of these artifacts are stated in a way where GenAI Synthesis can correlate and determine based on matching in certain ways what to rule out and what to include on how to bootstrap 104 to register all of those aspects. GenAI synthesis is what we define as the mechanism to which correlates all of these artifacts using matching techniques and then using a confidence factor to rule in most likely what API's are associated with what project or system needs/artifacts. For example, an API capability such as Listing Meter data is typically described in text of the API documents in a manner that is similar to the system requirements, etc. This is because a meter is a significant thing that needs to be explicitly stated in any of these artifacts that would distinguish it from any of the other aspects of these artifacts, at least to a degree of a confidence ranking to promote learning. As GenAI Synthesis is not to build and constrain, but rather learn by trail and error to correlate and replicate.

In an embodiment, components 302 and 306 (and respective components therein) define an input zone to the testing zone defined by components 102 and 104 (and respective components therein) Data elements 310-322 are provided as input to the LLM of GenAI execution component 304, such as through training, to configure the LLM with a deep, and nuanced understanding of the testing requirements and system architecture.

GenAI Synthesis: Leveraging advanced algorithms and machine learning techniques (e.g. of LLMs), the GenAI execution component 304 processes the collected data to identify relevant testing scenarios and requirements. It intelligently synthesizes information from the diverse inputs to generate synthesized data to define data-driven testing strategies, aligning test cases with system capabilities and API endpoints.

The synthesized data, including dynamically generated test scenarios and associated configurations, is then stored into database 104 e.g. to the tables 114A and 114B for test scenarios and test scenario data. This step effectively bootstraps the testing zone components (e.g. defining an integrated automated testing tool) with the necessary information to execute targeted, comprehensive tests.

With the bootstrap data in place, the testing zone components can proceed with executing the tests. The GenAI-generated data ensures that testing scenarios are not only aligned with current system configurations and business requirements but are also adaptable to changes. This integration maximizes the relevance and effectiveness of the testing process.

Using GenAI related components can facilitate several objectives. Dynamic Scenario Generation: By dynamically mapping test cases to API endpoints, GenAI significantly enhances the scope and accuracy of automated testing. It can be updated and executed to define new tests that are in sync with the latest system developments and requirements. Data-Driven Configuration: The AI-generated configurations for the testing zone components enable a precise and comprehensive evaluation of API responses against expected outcomes. This ensures a higher quality of testing, with detailed attention to the specificities of each test scenario. Streamlined Testing Process: The direct integration of GenAI output into the testing tool as data updates simplifies the testing workflow. It allows for a more agile response to changes in system architecture, reducing the time and effort required for test preparation and execution. Enhanced Test Relevance: By continually updating the testing scenarios and configurations based on the latest system information and requirements, GenAI ensures that the testing process remains highly relevant and effective over time.

The incorporation of the GenAI components into the automated testing framework represents a significant advancement in software testing technology. It transforms the approach to API testing from a static, manual process to a dynamic, AI-driven one. With GenAI, the system gains the ability to self-update and evolve, ensuring that testing scenarios are always optimized for the current system state and future developments. This integration not only improves testing accuracy and efficiency but also significantly reduces the time-to-market for new features and updates.

Features of the various environment embodiments thus include the following: Data-Driven API Request Generation: The system allows users to define API requests based on metadata and input parameters. It intelligently chains requests, creating a dynamic and adaptable process for generating API requests. Normalized Generic Response Handling: API responses, regardless of their complexity, are normalized into a consistent format for storage and analysis. The embodiments can dynamically adapt to different response structures, enhancing data quality.

The embodiments for end-to-end data-driven API testing and integration with metadata-driven programming presented herein offer a versatile and adaptable solution for data processing. It streamlines API testing, improves data quality, and enables automation, making it invaluable in various data-driven applications.

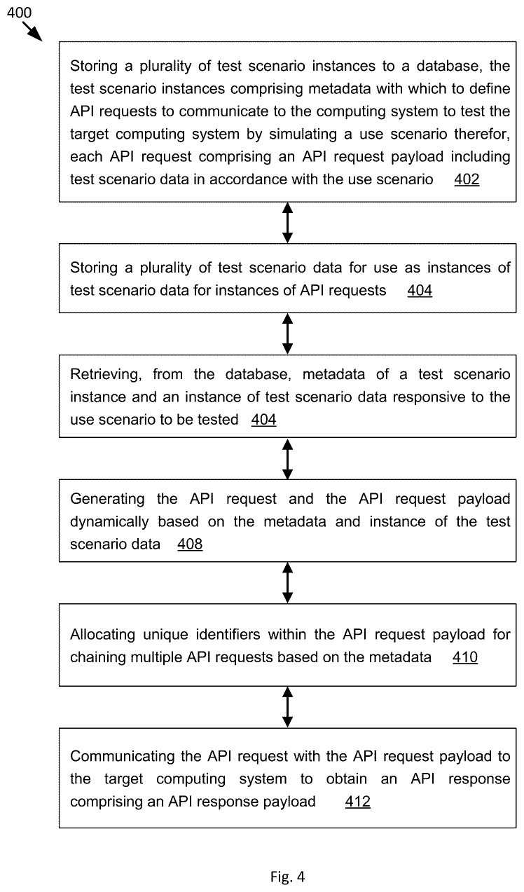

FIG. 4 is a flowchart of operations 400 of a computing system in accordance with an embodiment. In an embodiment the operations are performed by API testing device 102 of FIGS. 1 and/or 3 as is applicable. At 402, operations store a plurality of test scenario instances to a database, the test scenario instances comprising metadata with which to define API requests to communicate to the computing system to test the target computing system by simulating a use scenario therefor, each API request comprising an API request payload including test scenario data in accordance with the use scenario.

At 404, operations store a plurality of test scenario data for use as instances of test scenario data for instances of API requests. At 406, operations retrieving, from the database, metadata of a test scenario instance and an instance of test scenario data responsive to the use scenario to be tested;

At 408, operations generate the API request and the API request payload dynamically based on the metadata and instance of the test scenario data.

At 410, operations allocate unique identifiers within the API request payload for chaining multiple API requests based on the metadata. And at 412, operations communicate the API request with the API request payload to the target computing system to obtain an API response comprising an API response payload.

In an embodiment, the instance of test scenario data retrieved comprises one or more of a fixed data element or a dynamically generated data element. In an embodiment, the instance of test scenario data retrieved includes session data, API instructions, JSON structures, numeric values, or Boolean values, or combinations thereof.

In an embodiment, the unique identifiers within the API request payload enable chaining of multiple API requests by referencing previous API response data from previous API response payloads.

In an embodiment, the method comprises iterating through the multiple API requests in accordance with the metadata and API responses received in the chain.

In an embodiment, the method comprises receiving the API response in response to the API request; storing the API reply to the database. In an embodiment, the method comprises: parsing the API response to identify data elements of the API response payload; registering the identified data elements in a normalized fashion; and storing the normalized API response data in the database. The parsing step can identify JSON structures, arrays, nested objects, and simple data values within the API response. The registering step can create a structured representation of the API response data for analysis and comparison. In an embodiment, the method can comprise integrating the normalized API response data with incident response systems for automated incident management.

In an embodiment, the method can comprise performing error handling and error reporting in accordance with the API request and either the API response or absence of the API response.

In an embodiment, the method can comprise providing an interface with which to define at least some of the test scenario instances and at least some of the instances of test scenario data; receiving input via the interface; and defining the at least some of the test scenario instances and at least some of the instances of test scenario data. In an embodiment, the method can comprise processing the input using a generative artificial intelligence based large language model configured to process input comprising business requirements, API definitions, and metadata and/or database schema examples to generate at least one test scenario instance and test scenario data associated therewith.

In addition to computing device and method aspects, a person of ordinary skill will understand that computer program product aspects are disclosed, where instructions are stored in a non-transient storage device (e.g. a memory, CD-ROM, DVD-ROM, disc, etc.) and that, when executed, the instructions cause a computing device to perform any of the method aspects stored herein.

Practical implementation may include any or all of the features described herein. These and other aspects, features and various combinations may be expressed as methods, apparatus, systems, means for performing functions, program products, and in other ways, combining the features described herein. Several embodiments have been described. Nevertheless, it will be understood that various modifications can be made without departing from the spirit and scope of the processes and techniques described herein. In addition, other steps can be provided, or steps can be eliminated, from the described process, and other components can be added to, or removed from, the described systems. Accordingly, other embodiments are within the scope of the following claims.

Throughout the description and claims of this specification, the word “comprise” and “contain” and variations of them mean “including but not limited to” and they are not intended to (and do not) exclude other components, integers or steps. Throughout this specification, the singular encompasses the plural unless the context requires otherwise. In particular, where the indefinite article is used, the specification is to be understood as contemplating plurality as well as singularity, unless the context requires otherwise.

Features, integers characteristics, compounds, chemical moieties or groups described in conjunction with a particular aspect, embodiment or example of the invention are to be understood to be applicable to any other aspect, embodiment or example unless incompatible therewith. All of the features disclosed herein (including any accompanying claims, abstract and drawings), and/or all of the steps of any method or process so disclosed, may be combined in any combination, except combinations where at least some of such features and/or steps are mutually exclusive. The invention is not restricted to the details of any foregoing examples or embodiments. The invention extends to any novel one, or any novel combination, of the features disclosed in this specification (including any accompanying claims, abstract and drawings) or to any novel one, or any novel combination, of the steps of any method or process disclosed.

What is claimed is:

1. A computer implemented method of automated testing of a target computing system having one or more application programming interfaces (APIs) for interacting with the target computing system, the method comprising:
storing a plurality of test scenario instances to a database, the test scenario instances comprising metadata with which to define API requests to communicate to the computing system to test the target computing system by simulating a use scenario therefor, each API request comprising an API request payload including test scenario data in accordance with the use scenario;
storing a plurality of test scenario data for use as instances of test scenario data for instances of API requests;
retrieving, from the database, metadata of a test scenario instance and an instance of test scenario data responsive to the use scenario to be tested;
generating the API request and the API request payload dynamically based on the metadata and instance of the test scenario data;
allocating unique identifiers within the API request payload for chaining multiple API requests based on the metadata; and
communicating the API request with the API request payload to the target computing system to obtain an API response comprising an API response payload.

2. The method of claim 1, wherein the instance of test scenario data retrieved comprises one or more of a fixed data element or a dynamically generated data element.

3. The method of claim 1, wherein the instance of test scenario data retrieved includes session data, API instructions, JSON structures, numeric values, or Boolean values, or combinations thereof.

4. The method of claim 1, wherein the unique identifiers within the API request payload enable chaining of multiple API requests by referencing previous API response data from previous API response payloads.

5. The method of claim 1, comprising iterating through the multiple API requests in accordance with the metadata and API responses received in the chain.

6. The method of claim 1 comprising receiving the API response in response to the API request; storing the API reply to the database.

7. The method of claim 6 comprising: parsing the API response to identify data elements of the API response payload; registering the identified data elements in a normalized fashion; and storing the normalized API response data in the database.

8. The method of claim 7, wherein the parsing step identifies JSON structures, arrays, nested objects, and simple data values within the API response.

9. The method of claim 7, wherein the registering step comprises creating a structured representation of the API response data for analysis and comparison.

10. The method of claim 7, further comprising integrating the normalized API response data with incident response systems for automated incident management.

11. The method of claim 6 comprising performing error handling and error reporting in accordance with the API request and either the API response or absence of the API response.

12. The method of claim 1, comprising providing an interface with which to define at least some of the test scenario instances and at least some of the instances of test scenario data; receiving input via the interface; and defining the at least some of the test scenario instances and at least some of the instances of test scenario data.

13. The method of claim 12 comprising processing the input using a generative artificial intelligence based large language model configured to process input comprising business requirements, API definitions, and metadata and/or database schema examples to generate at least one test scenario instance and test scenario data associated therewith.

14. A test computing system comprising at least one processor and at least one storage device storing instructions that when executed by the at least one processor cause the computing system to automate testing of a target computing system having one or more application programming interfaces (APIs) for interacting with the target computing system, the instructions as executed cause the test computing system to:
store a plurality of test scenario instances to a database, the test scenario instances comprising metadata with which to define API requests to communicate to the computing system to test the target computing system by simulating a use scenario therefor, each API request comprising an API request payload including test scenario data in accordance with the use scenario;
store a plurality of test scenario data for use as instances of test scenario data for instances of API requests;
retrieve, from the database, metadata of a test scenario instance and an instance of test scenario data responsive to the use scenario to be tested;
generate the API request and the API request payload dynamically based on the metadata and instance of the test scenario data;
allocate unique identifiers within the API request payload for chaining multiple API requests based on the metadata; and
communicate the API request with the API request payload to the target computing system to obtain an API response comprising an API response payload.

15. The test computing system of claim 14, wherein the instance of test scenario data retrieved comprises one or more of a fixed data element or a dynamically generated data element.

16. The test computing system of claim 14, wherein the instance of test scenario data retrieved includes session data, API instructions, JSON structures, numeric values, or Boolean values, or combinations thereof.

17. The test computing system of claim 14, wherein the unique identifiers within the API request payload enable chaining of multiple API requests by referencing previous API response data from previous API response payloads.

18. The test computing system of claim 14, wherein the instructions as executed cause the test computing system to iterate through the multiple API requests in accordance with the metadata and API responses received in the chain.

19. The test computing system of claim 14, wherein the instructions as executed cause the test computing system to receive the API response in response to the API request; storing the API reply to the database.

20. The test computing system of claim 19, wherein the instructions as executed cause the test computing system to: parse the API response to identify data elements of the API response payload; register the identified data elements in a normalized fashion; and store the normalized API response data in the database.

21. The test computing system of claim 20, wherein to parse identifies JSON structures, arrays, nested objects, and simple data values within the API response.

22. The test computing system of claim 20, wherein to register comprises creating a structured representation of the API response data for analysis and comparison.

23. The test computing system of claim 20, wherein the instructions as executed cause the test computing system to integrate the normalized API response data with incident response systems for automated incident management.

24. The test computing system of claim 19, wherein the instructions as executed cause the test computing system to perform error handling and error reporting in accordance with the API request and either the API response or absence of the API response.

25. The test computing system of claim 14, wherein the instructions as executed cause the test computing system to: provide an interface with which to define at least some of the test scenario instances and at least some of the instances of test scenario data; receive input via the interface; and define the at least some of the test scenario instances and at least some of the instances of test scenario data.

26. The test computing system of claim 25, wherein the instructions as executed cause the test computing system to: process the input using a generative artificial intelligence based large language model configured to process input comprising business requirements, API definitions, and metadata and/or database schema examples to generate at least one test scenario instance and test scenario data associated therewith.
